(19) United States
(12) Patent Application Publication
(10) Pub. No.: US 2009/0080770 A1
(43) Pub. Date: Mar. 26, 2009

(54) IMAGE PIXEL SUBSAMPLING TO REDUCE A NUMBER OF PIXEL CALCULATIONS

(75) Inventors: Wenqing Jiang, San Jose, CA (US); Ying Cao, San Jose, CA (US); Li Hao, Cupertino, CA (US); Weiping Pan, San Jose, CA (US)

Correspondence Address: FIALA & WEAVER, P.L.L.C.;C/O INTELLEVATE, P.O. BOX 52050, MINNEAPOLIS, MN, 55402, US

(73) Assignee: BROADCOM CORPORATION, Irvine, CA (US)

(21) Appl. No.: 11/860,164

(22) Filed: Sep. 24, 2007

(51) Int. Cl. G06K 9/40

(52) U.S. Cl. 382/164

(57) ABSTRACT

Methods, systems, and apparatuses for processing captured image data are described. A first array of pixel data values corresponding to a captured image is received. The first array is segmented into a plurality of N by M array portions. A subsample pattern is selected for each N by M array portion of the plurality of N by M array portions from a plurality of subsample patterns so that each N by M array portion has a corresponding selected subsample pattern. The subsample patterns may be selected in a random fashion, or other fashion, to avoid noise patterns in a spatial domain (same image frame) and/or in a time domain (across multiple image frames). Each N by M array portion is subsampled according to the corresponding selected subsample pattern to generate a second array of filtered pixel data values. The second array of filtered pixel data values corresponds to a down-sized version of the captured image. This process may be performed on data of multiple color channels corresponding to the captured image, and on data corresponding to multiple captured image frames in a video stream.

### BACKGROUND OF THE INVENTION

1. Field of the Invention

The present invention relates to image data filtering.

2. Background Art

An increasing number of devices are being produced that are enabled to capture and display images. For example, mobile devices, such as cell phones, are increasingly being equipped with cameras to capture images, including still snapshots and motion video recording. Images captured by such devices can frequently be viewed on displays of the devices, as well as being transferred from the devices for viewing elsewhere. To view the images on relatively small devices, the images typically must be viewed on small display screens that are not capable of viewing the full resolution of the captured images. Thus, such devices must include at least limited image processing capability to down-size the images for viewing on the small display screens.

Many mobile devices have limited processing capability due to cost, power consumption, and size constraints. However, the processing of captured images, especially the processing of video, is very computationally intensive. For example, many mobile devices have cameras capable of capturing images of 2 MegaPixels (MPel) or more. Thus, a processor of such a mobile device must be capable of processing a large amount of data for each captured image. Furthermore, encoding and decoding (e.g., QCIF) of image data may need to be performed by the processor at frame rates such as 15 fps and 30 fps, respectively, as well as the performance of other functions.

To deal with such high-resource demanding tasks, mobile device developers have resorted to including high-powered processing chips in the devices, which have higher clock rates and larger on-chip cache memory, or to including dedicated video/image processing chips. Such approaches result in higher cost devices with higher levels of power consumption, which may not be desirable in battery powered mobile devices.

Thus, ways are desired for handling an image processing workload in devices, such as mobile devices, without significantly raising device costs and power consumption levels.

### BRIEF SUMMARY OF THE INVENTION

Methods, systems, and apparatuses are described for processing captured image data in devices. Subsampling is performed according to selected subsample patterns to down-size a captured image frame. The subsample patterns used for subsampling may be selected in a random or other fashion, to avoid repetition of sample patterns in a spatial domain (same image frame) and/or in a time domain (across multiple image frames). Subsampling in this manner avoids fixed noise patterns and/or other image issues, for example.

In a first example, a first array of pixel data values corresponding to a captured image is received. The first array is segmented into a plurality of N by M array portions. A subsample pattern is selected for each N by M array portion of the plurality of N by M array portions from a plurality of subsample patterns so that each N by M array portion has a corresponding selected subsample pattern. Each N by M array portion is subsampled according to the corresponding selected subsample pattern to generate a second array of filtered pixel data values. The second array of filtered pixel data values corresponds to a down-sized version of the captured image.

In an example aspect, the subsampling of each N by M array portion includes calculating a filtered pixel data value for each N by M array portion. A filtered pixel data value is calculated by applying a function to a subset of the pixel data values of an array portion according to the corresponding selected subsample pattern. By using a subset of the pixel data values, a number of calculations is reduced compared to using all of the pixel data values of an N by M array portion.

Pixel data arrays of multiple color channels corresponding to the captured image may each be processed in this manner. Furthermore, pixel data arrays corresponding to additional captured image frames in a video stream may be processed in this manner.

In a further example, an image subsampling system includes an image array portion selector, a subsampling pattern selector, and a subsampling module. The image array portion selector is configured to select N by M array portions from a first array of pixel data values that correspond to a captured image. The subsampling pattern selector is configured to select a subsample pattern for each N by M array portion from a plurality of subsample patterns. Each N by M array portion has a corresponding selected subsample pattern. The subsampling module is configured to subsample each N by M array portion according to the corresponding selected subsample pattern to generate a second array of filtered pixel data values. The second array of filtered pixel data values corresponds to a down-sized version of the captured image.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of an example mobile device with image capture and processing capability.

FIG. 2 shows a sensor array of an example image sensor device, having a two-dimensional array of pixel sensors.

FIG. 3 shows a block diagram representation of image data included in an image signal for an image captured by an image sensor device.

FIG. 4 illustrates image data in array form, as captured by an image sensor.

FIG. 5 shows example red, green, and blue color channels generated by an image processor from image data.

FIG. 6 shows an image data word formatted according to a standard implementation, containing 16-bits and including red, green, and blue color channel data.

FIG. 7 shows a block diagram representation of image downsizing.

FIG. 8 shows a flowchart providing example steps for processing a captured image, according to an example embodiment of the present invention.

FIG. 9 shows an array of pixel data values corresponding to a captured image, segmented into a plurality of array portions, according to an example embodiment of the present invention.

FIG. 10 shows an example array portion that was segmented from an image data array according to an example embodiment of the present invention.

FIGS. 11-14 show example subsample patterns, according to embodiments of the present invention.

FIG. 15 shows an array of filtered pixel data values, according to an example embodiment of the present invention.

FIG. 16 shows an additional step for the flowchart of FIG. 8, according to an example embodiment of the present invention.

FIG. 17 shows a block diagram of an image subsampling system, according to an embodiment of the present invention.

FIG. 18 shows a block diagram of a subsampling pattern selector that includes a random number generator, according to an embodiment of the present invention.

FIG. 19 shows a flowchart providing example steps for selecting subsample patterns according to an index array, according to an embodiment of the present invention.

FIG. 20 shows an example index array, according to an embodiment of the present invention.

FIG. 21 shows a step that may be performed in the flowchart of FIG. 8, according to an example embodiment of the present invention.

FIG. 22 shows first, second, and third arrays of pixel data values, corresponding to three sequentially captured images of a video stream, according to an example embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### Image Processing in Mobile Devices

Embodiments of the present invention relate to image processing performed in devices. For example, embodiments include mobile devices where image processing must be performed with limited resources. Types of such mobile devices include mobile phones (e.g., cell phones), handheld computing devices (e.g., personal digital assistants (PDAs), BLACKBERRY devices, PALM devices, etc.), handheld music players (e.g., APPLE IPODs, MP3 players, etc.), and further types of mobile devices. Such mobile devices may include a camera used to capture images, such as still images and video images. The captured images are processed internal to the mobile device.

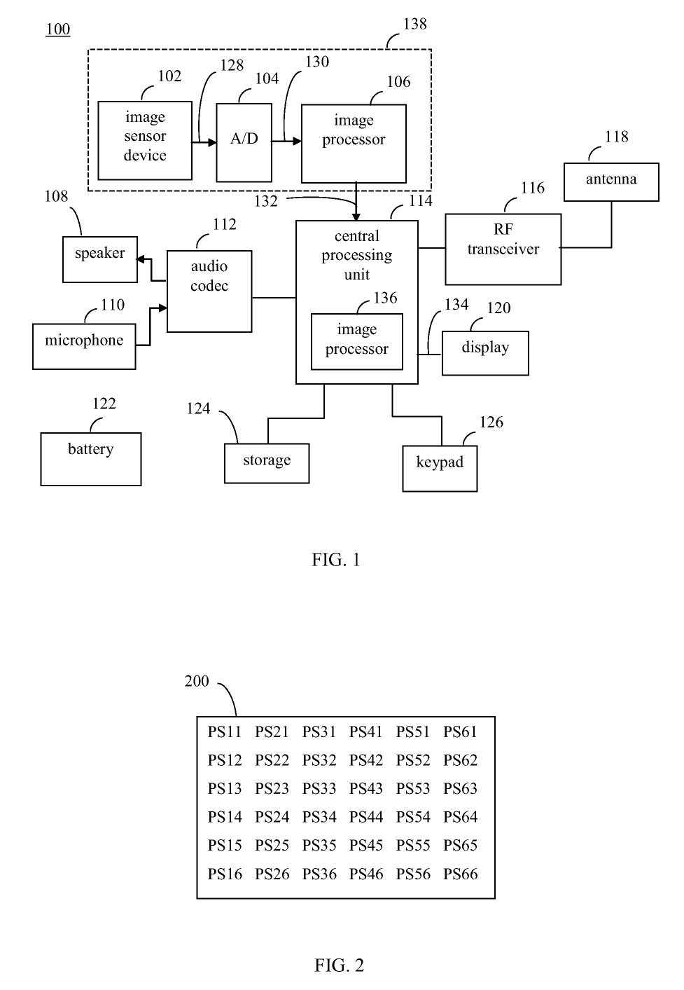

FIG. 1 shows a block diagram of an example mobile device 100 with image capture and processing capability. Mobile device 100 may be a mobile phone, a handheld computing device, a music player, etc. The implementation of mobile device 100 shown in FIG. 1 is provided for purposes of illustration, and is not intended to be limiting. Embodiments of the present invention are intended to cover mobile devices having additional and/or alternative features to those shown for mobile device 100 in FIG. 1.

As shown in FIG. 1, mobile device 100 includes an image sensor device 102, an analog-to-digital (A/D) 104, an image processor 106, a speaker 108, a microphone 110, an audio codec 112, a central processing unit (CPU) 114, a radio frequency (RF) transceiver 116, an antenna 118, a display 120, a battery 122, a storage 124, and a keypad 126. These components are typically mounted to or contained in a housing. The housing may further contain a circuit board mounting integrated circuit chips and/or other electrical devices corresponding to these components. Each of these components of mobile device 100 is described as follows.

Battery 122 provides power to the components of mobile device 100 that require power. Battery 122 may be any type of battery, including one or more rechargeable and/or non-rechargeable batteries.

Keypad 126 is a user interface device that includes a plurality of keys enabling a user of mobile device 100 to enter data, commands, and/or to otherwise interact with mobile device 100. Mobile device 100 may include additional and/or alternative user interface devices to keypad 126, such as a touch pad, a roller ball, a stick, a click wheel, and/or voice recognition technology.

Image sensor device 102 is an image capturing device. For example, image sensor device 102 may include an array of photoelectric light sensors, such as a charge coupled device (CCD) or a CMOS (complementary metal-oxide-semiconductor) sensor device. Image sensor device 102 typically includes a two-dimensional array of sensor elements organized into rows and columns. For example, FIG. 2 shows a sensor array 200, which is an example of image sensor device 102, having a two-dimensional array of pixel sensors (PS). Sensor array 200 is shown in FIG. 2 as a six-by-six array of thirty-six (36) pixel sensors for ease of illustration. Sensor array 200 may have any number of pixel sensors, including hundreds of thousands or millions of pixel sensors. Each pixel sensor is shown in FIG. 2 as “PSxy”, where “x” is a row number, and “y” is a column number, for any pixel sensor in the array of sensor elements. In embodiments, each pixel sensor of image sensor device 102 is configured to be sensitive to a specific color, or color range. In one example, three types of pixel sensors are present, including a first set of pixel sensors that are sensitive to the color red, a second set of pixel sensors that are sensitive to green, and a third set of pixel sensors that are sensitive to blue. Image sensor device 102 receives light corresponding to an image, and generates an analog image signal 128 corresponding to the captured image. Analog image signal 128 includes analog values for each of the pixel sensors.

A/D 104 receives analog image signal 128, converts analog image signal 128 to digital form, and outputs a digital image signal 130. Digital image signal 130 includes digital representations of each of the analog values generated by the pixel sensors, and thus includes a digital representation of the captured image. For instance, FIG. 3 shows a block diagram representation of image data 300 included in digital image signal 130 for an image captured by image sensor device 102. As shown in FIG. 3, image data 300 includes red pixel data 302, green pixel data 304, and blue pixel data 306. Red pixel data 302 includes data related to pixel sensors of image sensor device 102 that are sensitive to the color red. Green pixel data 304 includes data related to pixel sensors of image sensor device 102 that are sensitive to the color green. Blue pixel data 306 includes data related to pixel sensors of image sensor device 102 that are sensitive to the color blue.

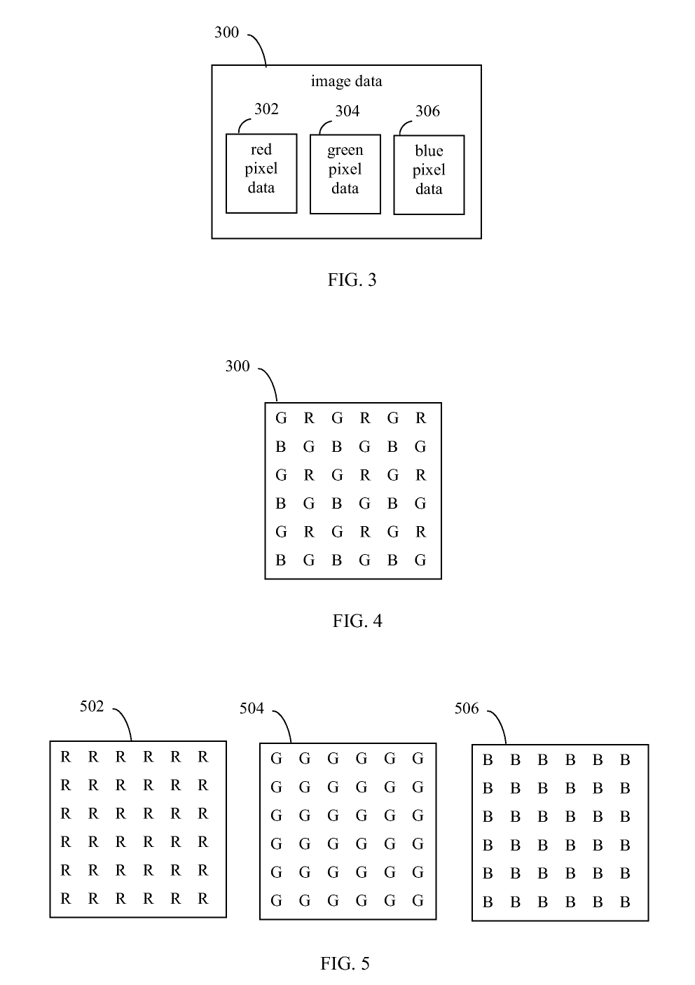

FIG. 4 illustrates image data 300 in array form, as captured by image sensor 102. In FIG. 4, “R” represents red pixel data captured by a corresponding pixel sensor of image sensor device 102, “G” represents green pixel data captured by a corresponding pixel sensor of image sensor device 102, and “B” represents blue pixel data captured by a corresponding pixel sensor of image sensor device 102. Referring back to FIG. 2, alternating pixel sensors PS11, PS31, and PS51 of the first row of sensor array 200 may be sensitive to green light, and thus may correspond to a “G” in FIG. 4, having generated green light data. Alternating pixel sensors PS21, PS41, and PS61 of the first row of sensor array 200 may be sensitive to red light, and thus may correspond to an “R” in FIG. 4, having generated red light data. In the second row of sensor array 200, alternating pixel sensors PS12, PS32, and PS52 may be sensitive to blue light, and thus may correspond to a “B” in FIG. 4, having generated blue light data. Alternating pixel sensors PS22, PS42, and PS62 of the second row of sensor array 200 may be sensitive to green light, and thus may correspond to a “G” in FIG. 4, having generated green light data. The color pattern of the first and second rows of sensor array 200 shown in FIG. 4 may be repeated in sensor array 200 for subsequent rows, as shown in FIG. 4.

The pixel pattern shown for image data 300 in FIG. 4 is called a Bayer pattern image. A Bayer filter mosaic is a color filter array (CFA) for arranging RGB color filters on the array of pixel sensors in image sensor device 102 to generate the Bayer pattern image. The Bayer pattern arrangement of color filters is used in many image sensors of devices such as digital cameras, camcorders, scanners, and mobile devices to create a color image. The filter pattern is 50% green, 25% red and 25% blue, hence is also referred to as “RGBG” or “GRGB.” The green pixel sensors are referred to as “luminance-sensitive” elements, and the red and blue pixel sensors are referred to as “chrominance-sensitive” elements. Twice as many green pixel sensors are used as either of the red or blue pixel sensors to mimic the greater resolving power of the human eye with green light wavelengths. Alternatives to the Bayer pattern image may also be used, which include the CYGM filter (cyan, yellow, green, magenta) and RGBE filter (red, green, blue, emerald), which require demosaicing, and the Foveon X3 sensor, which layers red, green, and blue sensors vertically rather than using a mosaic.

Image processor 106 receives digital image signal 130. Image processor 106 performs image processing of the digital pixel sensor data received in digital image signal 130. For example, image processor 106 may be used to generate pixels of all three colors at all pixel positions when a Bayer pattern image is output by image sensor device 102. Image processor 106 may perform a demosaicing algorithm to interpolate red, green, and blue pixel data values for each pixel position of the array of image data 200 shown in FIG. 4. For example, FIG. 5 shows a red color channel 502, a green color channel 504, and a blue color channel 506 generated by image processor 106 from image data 300. Each of red, green, and blue color channels 502, 504, and 506 includes a full array of image data for red, green, and blue, respectively, generated from image data 300 of FIG. 3. In other words, red color channel 502 includes a full array of red pixel data values, where a red pixel data value is generated for the position of each “G” and “B” pixel data value shown for image data 300 in FIG. 4, such as by averaging the values of the surrounding existing “R” pixel data values. In a likewise manner, a full array of green pixel data values is generated for green color channel 504 and a full array of blue pixel data values is generated for blue color channel 504. Thus, each of red, green, and blue color channels 502, 504, and 506 is an array of data values the size of the array of image data 300 shown in FIG. 4.

Image processor 106 performs processing of digital image signal 130, such as described above, and generates an image processor output signal 132. Image processor output signal 132 includes processed pixel data values that correspond to the image captured by image sensor device 102. Image processor output signal 132 includes color channels 502, 504, and 506, which each include a corresponding full array of pixel data values, respectively representing red, green, and blue color images corresponding to the captured image.

Note that in an embodiment, two or more of image sensor device 102, A/D 104, and image processor 106 may be included together in a single IC chip, such as a CMOS chip, particularly when image sensor device 102 is a CMOS sensor, or may be in two or more separate chips. For instance, FIG. 1 shows image sensor device 102, A/D 104, and image processor 106 included in a camera module 138, which may be a single IC chip in an example embodiment.

CPU 114 is shown in FIG. 1 as coupled to each of image processor 106, audio codec 112, RF transceiver 116, display 120, storage 124, and keypad 126. CPU 114 may be individually connected to these components, or one or more of these components may be connected to CPU 114 in a common bus structure.

Microphone 110 and audio CODEC 112 may be present in some applications of mobile device 100, such as mobile phone applications and video applications (e.g., where audio corresponding to the video images is recorded). Microphone 110 captures audio, including any sounds such as voice, etc. Microphone 110 may be any type of microphone. Microphone 110 generates an audio signal that is received by audio codec 112. The audio signal may include a stream of digital data, or analog information that is converted to digital form by an analog-to-digital (A/D) converter of audio codec 112. Audio codec 112 encodes (e.g., compresses) the received audio of the received audio signal. Audio codec 112 generates an encoded audio data stream that is received by CPU 114.

CPU 114 receives image processor output signal 132 from image processor 106 and receives the audio data stream from audio codec 112. As shown in FIG. 1, CPU 114 includes an image processor 136. In embodiments, image processor 136 performs image processing (e.g., image filtering) functions for CPU 114. In an embodiment, CPU 114 includes a digital signal processor (DSP), which may be included in image processor 136. When present, the DSP may apply special effects to the received audio data (e.g., an equalization function) and/or to the video data. CPU 114 may store and/or buffer video and/or audio data in storage 124. Storage 124 may include any suitable type of storage, including one or more hard disc drives, optical disc drives, FLASH memory devices, etc. In an embodiment, CPU 114 may stream the video and/or audio data to RF transceiver 116, to be transmitted from mobile device 100.

When present, RF transceiver 116 is configured to enable wireless communications for mobile device 116. For example, RF transceiver 116 may enable telephone calls, such as telephone calls according to a cellular protocol. RF transceiver 116 may include a frequency up-converter (transmitter) and down-converter (receiver). For example, RF transceiver 116 may transmit RF signals to antenna 118 containing audio information corresponding to voice of a user of mobile device 100. RF transceiver 116 may receive RF signals from antenna 118 corresponding to audio information received from another device in communication with mobile device 100. RF transceiver 116 provides the received audio information to CPU 114. In another example, RF transceiver 116 may be configured to receive television signals for mobile device 100, to be displayed by display 120. In another example, RF transceiver 116 may transmit images captured by image sensor device 102, including still and/or video images, from mobile device 100. In another example, RF transceiver 116 may enable a wireless local area network (WLAN) link (including an IEEE 802.11 WLAN standard link), and/or other type of wireless communication link.

CPU 114 provides audio data received by RF transceiver 116 to audio codec 112. Audio codec 112 performs bit stream decoding of the received audio data (if needed) and converts the decoded data to an analog signal. Speaker 108 receives the analog signal, and outputs corresponding sound.

Image processor 106, audio codec 112, and CPU 114 may be implemented in hardware, software, firmware, and/or any combination thereof. For example, CPU 114 may be implemented as a proprietary or commercially available processor, such as an ARM (advanced RISC machine) core configuration, that executes code to perform its functions. Audio codec 112 may be configured to process proprietary and/or industry standard audio protocols. Image processor 106 may be a proprietary or commercially available image signal processing chip, for example.

Display 120 receives image data from CPU 114, such as image data generated by image processor 106. For example, display 120 may be used to display images captured by image sensor device 102. Display 120 may include any type of display mechanism, including an LCD (liquid crystal display) panel or other display mechanism.

Depending on the particular implementation, image processor 106 formats the image data output in image processor output signal 132 according to a proprietary or known video data format. Display 120 is configured to receive the formatted data, and to display a corresponding captured image. In one example, image processor 106 may output a plurality of data words, where each data word corresponds to an image pixel. A data word may include multiple data portions that correspond to the various color channels for an image pixel. Any number of bits may be used for each color channel, and the data word may have any length.

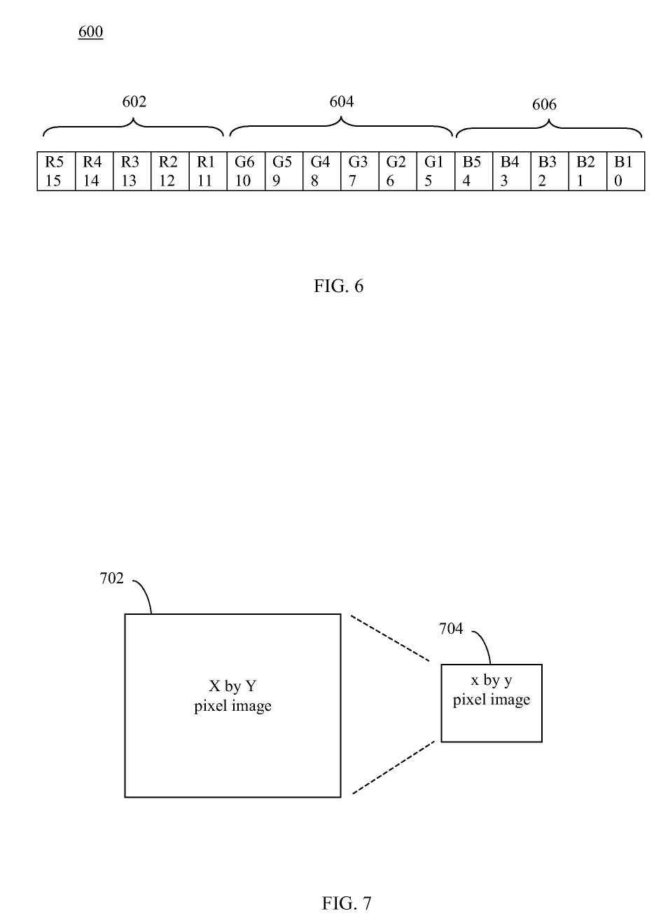

For instance, in one standard implementation, the data word may be a 24-bit data word that includes 8 bits for the red color channel, 8 bits for the green color channel, and 8 bits for the blue color channel. In another standard implementation, as shown in FIG. 6, a data word 600 generated by image processor 106 may include 16-bits to represent an image pixel. As shown in FIG. 6, data word 600 includes 5 bits for the red color channel (R1-R5), shown as word portion 602, 6 bits for the green color channel (G1-G6), shown as word portion 604, and 5 bits for the blue color channel (B5-B1) shown as word portion 606. Word portion 602 (red) is packed in data word 600 as the highest order bits, word portion 604 (green) forms the middle order bits, and word portion 606 (blue) forms the lowest order bits. Note that these data word examples are provided for purposes of illustration, and that any data word format may be accommodated by embodiments of the present invention.

In some implementations, display 120 has a display screen that is not capable of viewing the full resolution of the images captured by image sensor device 102. Image sensor devices 102 may have various sizes, including numbers of pixels in the hundreds of thousand, or millions, such as 1 megapixel (Mpel), 2 Mpels, 4 Mpels, 8 Mpels, etc.). Display 120 may be capable of displaying relatively smaller image sizes. In one example, an image captured by image sensor device 102 may be 640 pixels by 480 pixels in size (307,200 pixels). In contrast, a display screen of display 120 may be 128 pixels by 96 pixels in size (12,288 pixels). Thus, display 120 (having a 12,288 pixel screen size) is not capable of displaying the entire captured image (having 307,200 pixels) at once.

To accommodate such differences between a size of display 120 and a size of captured images, CPU 114 (e.g., image processor 136) must down-size a captured image received from image processor 106 before providing the image to display 120. This is illustrated in FIG. 7, where an X by Y pixel image 702, captured by an image sensor, must be down-sized to an x by y pixel image 704, for display on the relatively small display screen of display 120 of mobile device 100. In the current example, CPU 114 must down-size the captured image by 25 times (307,200/12,288).

Such image downsizing may be performed by a subsampling process. In computer graphics, subsampling is a process used to reduce an image size. Subsampling is a type of image scaling, and may alter the appearance of an image or reduce the quantity of information required to store an image. Two types of subsampling are replacement and interpolation. The replacement technique selects a single pixel from a group and uses it to represent the entire group. The interpolation technique uses a statistical sample of the group (such as a mean) to create a new representation of the entire group.

In a subsampling process used in the current example, a captured image pixel array of 307,200 pixel data values may be divided into a plurality of sections having 25 pixels each. An averaging function can be performed on the 25 pixel data values of each section to generate a single representative pixel for display for each section. In this manner, an averaged pixel is generated for each section of 25 pixels, creating an image of 12,288 averaged pixels for display by display 120. However, performing an averaging function on 25 pixel data values requires a large number of operations. For example, the following equation (Equation 1) represents an averaging function for a number P of pixels:

$$Average = {\sum }_{i = 1}^{P} {a}_{i} {PS}_{i} \\ where \text{:} \\ {a}_{i} = scaling \text{/} weighing factor for the ith pixel , and \\ {PS}_{i} = pixel data value the ith pixel . \qquad Equation 1$$

For the current example of P=25 pixels, each aᵢ may be equal to 1/25 for uniform averaging. In one implementation, a total of 49 operations must be performed to determine an average, including 25 multiplication operations and 24 addition operations. Each multiplication and addition operation may take more than one CPU cycle, leading to a fairly large number of operations required to process a single pixel data value. Furthermore, this averaging function must be performed 12,288 times to generate 12,288 average pixels. Still further, this averaging operation must be performed for every captured image frame in a captured video stream. Encoding and decoding (e.g., QCIF) functions may also need to be performed by CPU 114 on the video data, at frame rates such as 15 fps and 30 fps, respectively, as well as performing other functions required by CPU 114. The processing of captured images greatly adds to the workload of CPU 114.

To handle the increased processing load, mobile devices 100 typically are provided with high performance CPUs and/or special purpose image processing chips, which are expensive and consume greater amounts of power, in an undesired manner. Embodiments of the present invention overcome deficiencies of conventional mobile devices. Embodiments enable the down-sizing and display of captured images on mobile devices, while reducing CPU performance and power consumption requirements. Example embodiments are described in the following section.

### EXAMPLE EMBODIMENTS

The example embodiments described herein are provided for illustrative purposes, and are not limiting. The examples described herein may be adapted to any type of mobile device. Furthermore, additional structural and operational embodiments, including modifications/alterations, will become apparent to persons skilled in the relevant art(s) from the teachings herein.

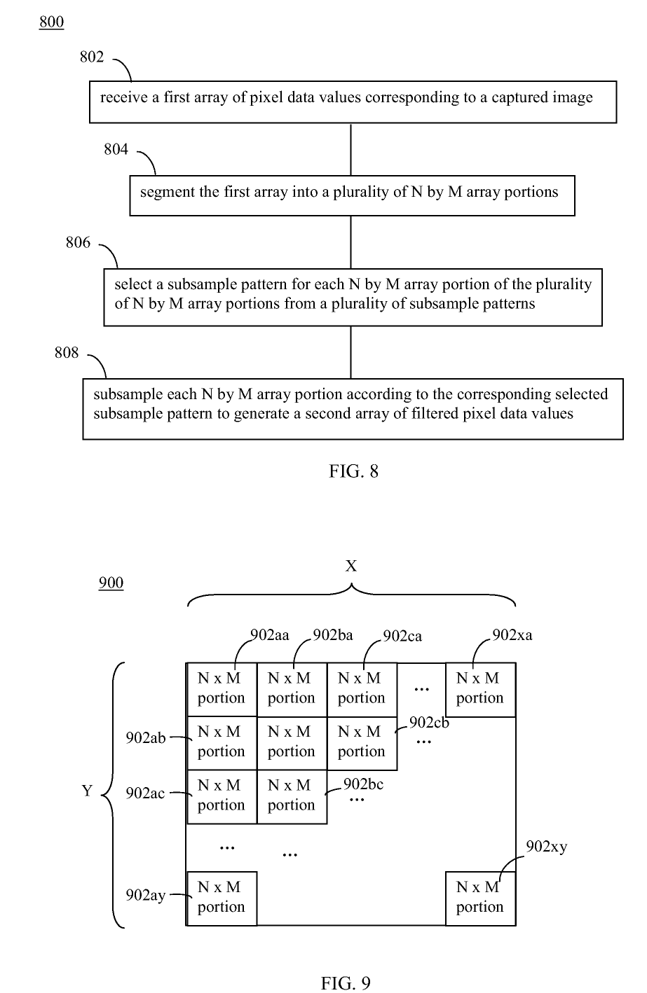

In embodiments of the present invention, enhanced subsampling techniques are used to filter an image, while reducing a number of required calculations as compared to conventional techniques. FIG. 8 illustrates an example subsampling technique of the present invention. FIG. 8 shows a flowchart 800 providing example steps for processing a captured image, according to an example embodiment of the present invention. FIG. 8 is described with respect to FIGS. 9-16 for illustrative purposes. Other structural and operational embodiments will be apparent to persons skilled in the relevant art(s) based on the discussion regarding flowchart 800. Flowchart 800 is described as follows.

Flowchart 800 begins with step 802. In step 802, a first array of pixel data values corresponding to a captured image is received. For example, the first array of pixel data values may be one of color channels 502, 504, or 506 shown in FIG. 5 output by image processor 106, corresponding to an image captured by an image capturing device (such as image sensor device 102 shown in FIG. 1). The received first array may have any size, including having hundreds of thousands, millions, or more, of pixels data values.

In step 804, the first array is segmented into a plurality of N by M array portions. For example, FIG. 9 shows an array 900 of pixel data values that is segmented into a plurality of N by M array portions 902aa-902xy. Array 900 has a width of “X” pixel data values and a height of “Y” pixel values. Array 900 can be segmented into any number of N by M array portions. In the current example, array 900 is segmented to have a number “x” of array portions 902 along its width, and to have a number “y” of array portions 902 along its height. Each N by M array portion 902 of the plurality of N by M array portions 902aa-902xy includes a plurality of pixel data values. Each N by M array portion 902 has a number “N” of pixel data values along its width, and a number “M” of pixel data values along its height. Array 900 is segmented such that:

X≧x×N, and

Y≧y×M.

Width “X′ and height “Y” of array 900 may have the same or different values. Width “N′ and height “M” of array portions 902 may have the same or different values.

FIG. 10 shows an N by M array portion 1000, which is an example of an N by M array portion 902 of FIG. 9. As shown in FIG. 10, N by M array portion 1000 includes a 5 by 5 array (N=5, M=5) of red pixel data values 1002 (R₁₁-R₅₅). In the current example, portion 1000 was segmented from a first array of red pixel data values, such as red color channel 502 shown in FIG. 5. Portion 1000 is shown as a 5 by 5 array of red pixel data values for illustrative purposes. In alternative embodiments, portion 1000 may have a size other than 5 by 5, and may include pixel data values of a color other than red.

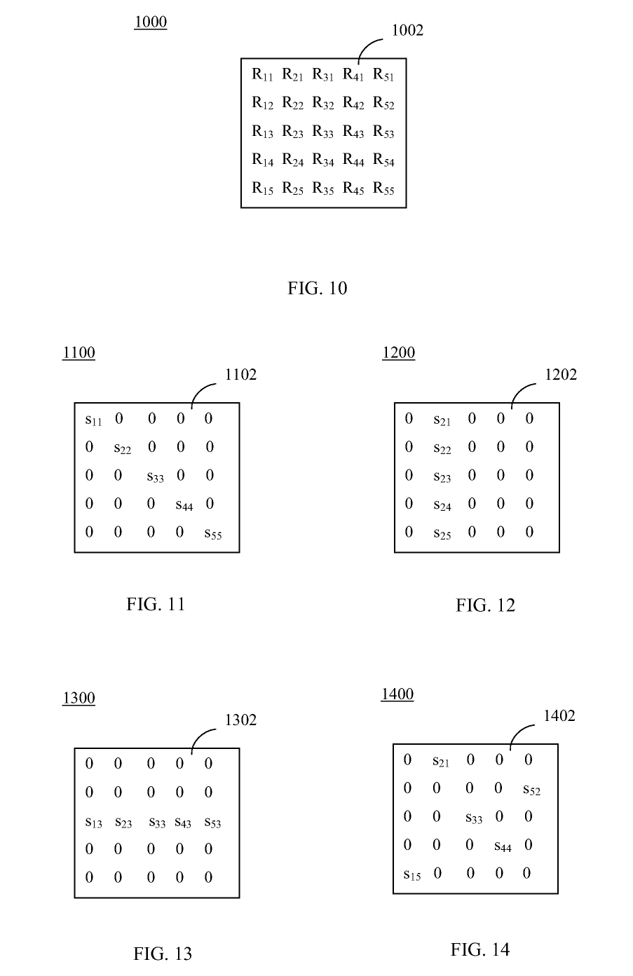

In step 806, a subsample pattern is selected for each N by M array portion of the plurality of N by M array portions. In an embodiment, subsample patterns are selected from a plurality of subsample patterns so that each N by M array portion (such as N by M array portion 1000) has a corresponding selected subsample pattern. FIGS. 11-14 show subsample patterns 1100, 1200, 1300, and 1400, respectively, as example 5 by 5 subsample patterns that may be applied to portion 1000 shown in FIG. 10 (as described below according to step 808).

Subsample pattern 1100 of FIG. 11 is an example diagonal bar pattern. Subsample pattern 1100 includes subsampling scaling values S₁₁, S₂₂, S₃₃, S₄₄, and S₅₅ at their indicated coordinates along a diagonal of subsample pattern 1100. The remaining coordinates of the 5 by 5 array of subsample pattern 1100 are populated with 0 scaling values.

Subsample pattern 1200 of FIG. 12 is an example vertical bar pattern. Subsample pattern 1200 includes subsampling scaling values S₂₁, S₂₂, S₂₃, S₂₄, and S₂₅ at their indicated coordinates along a second column of subsample pattern 1200. The remaining coordinates of the 5 by 5 array of subsample pattern 1200 are populated with 0 scaling values.

Subsample pattern 1300 of FIG. 13 is an example horizontal bar pattern. Subsample pattern 1300 includes subsampling scaling values S₁₃, S₂₃, S₃₃, S₄₃, and S₅₃ at their indicated coordinates along a third row of subsample pattern 1300. The remaining coordinates of the 5 by 5 array of subsample pattern 1300 are populated with 0 scaling values.

Subsample pattern 1400 of FIG. 14 is an example irregular pattern. Subsample pattern 1400 includes subsampling scaling values S₂₁, S₅₂, S₃₃, S₄₄, and S₁₅ at their indicated coordinates of subsample pattern 1400. The remaining coordinates of the 5 by 5 array of subsample pattern 1400 are populated with 0 scaling values.

Five non-zero subsampling scaling values are used and arranged in subsample patterns 1100 and 1400 so that a minimal number of non-zero scaling values is used, while having one non-zero scaling value in each column and row. In contrast, in subsample pattern 1200, each row has a non-zero scaling value, while only one column (the second column) has non-zero scaling values. In subsample pattern 1300, each column has a non-zero scaling value, while only one row (the third row) has non-zero scaling values. In further patterns, one or more rows and/or columns may not include a non-zero scaling value, may include a single non-zero scaling value, or may include multiple non-zero scaling values.

Subsample patterns 1100, 1200, 1300, and 1400 are provided for purposes of illustration. Any type of subsample pattern may be used, including any number of coordinates having non-zero subsampling scaling values. For example, subsample patterns 1100, 1200, 1300, and 1400 each include 5 non-zero subsampling scaling values “s_{xy}.” More than 5 or less than 5 non-zero subsampling scaling values may be used, as desired for the particular application. Furthermore, any configuration of non-zero subsampling scaling values may be present in a subsample pattern, including one or more full or partially full horizontal bars, one or more full or partially full vertical bars, one or more full or partially full diagonal bars, one or more “X” patterns, a quincunx pattern, a full or partially full shape such as a circle, a rectangle, or a diamond, other pattern, or any irregular pattern.

In step 808, each N by M array portion is subsampled according to the corresponding selected subsample pattern to generate a second array of filtered pixel data values. In embodiments, a filtered pixel data value is calculated for each N by M array portion by applying the selected subsample pattern. The filtered pixel data value is calculated by applying a function to a subset of the pixel data values of the N by M array portion according to the corresponding selected subsample pattern.

For instance, continuing the present example, subsample pattern 1100 of FIG. 11 may be selected to be applied to N by M array portion 1002 of FIG. 10. N by M array portion 1002 is subsampled by subsample pattern 1100 according to the following function:

filtered pixel data value=S₁₁R₁₁+S₂₂R₂₂+S₃₃R₃₃+S₄₄R₄₄+S₅₅R₅₅ Equation 2

In Equation 2 above, multiplications involving subsample scaling values that are equal to zero are not performed, and thus are not shown. In an embodiment, the red pixel data values of N by M array portion 1002 may have bit lengths of 5 bits (as in FIG. 6). Example 5-bit values for R₁₁, R₂₂, R₃₃, R₄₄, and R₅₅ are provided as follows (for purposes of the current example) in decimal form:

R₁₁=16

R₂₂=7

R₃₃=23

R₄₄=31

R₅₅=3

Subsampling scaling values S₁₁, S₂₂, S₃₃, S₄₄, and S₅₅ may all have the same value, or may have different values, as desired. For instance, in the present example, S₁₁, S₂₂, S₃₃, S₄₄, and S₅₅ may have equal weighting, and are equal to ⅕ (0.2). Thus, a filtered pixel data value may be calculated according to the Equation 2 for the present example, as follows:

filtered pixel data value=(0.2)16+(0.2)7+(0.2)23+(0.2)31+(0.2)3=16

Thus, in the current example, a red filtered data pixel for N by M array portion 1002 of FIG. 10, having the above example values for R₁₁, R₂₂, R₃₃, R₄₄, and R₅₅, and corresponding subsampling scaling values of 0.2, is calculated to be 16.

Equation 2 shown above for calculating a filtered pixel data value for an N by M array portion can be generalized as follows:

$$FPDV = {\sum }_{i = 1}^{N} {\sum }_{j = 1}^{M} {s}_{i , j} {PDV}_{i , j} \\ where \text{:} \\ {s}_{xy} = scaling \text{/} weighting factor ( S ) for the i , j pixel data value , and \\ {PDV}_{i} = pixel data value at i , j coordinate of the N by M array portion . \qquad Equation 3$$

As described above, subsampling scaling values s₁₁-s_{xy} can have zero or non-zero values, depending on the configuration of the particular subsampling pattern. In embodiments, at least some of the scaling values s₁₁-s_{xy} have zero values. Because some of scaling values s₁₁-S_{xy} have zero values, calculations do not need to be performed in Equation 3 on all pixel data values of each N by M array portion. This reduces a number of required calculations to generate a down-sized image array, and thus reduces an overall processing load.

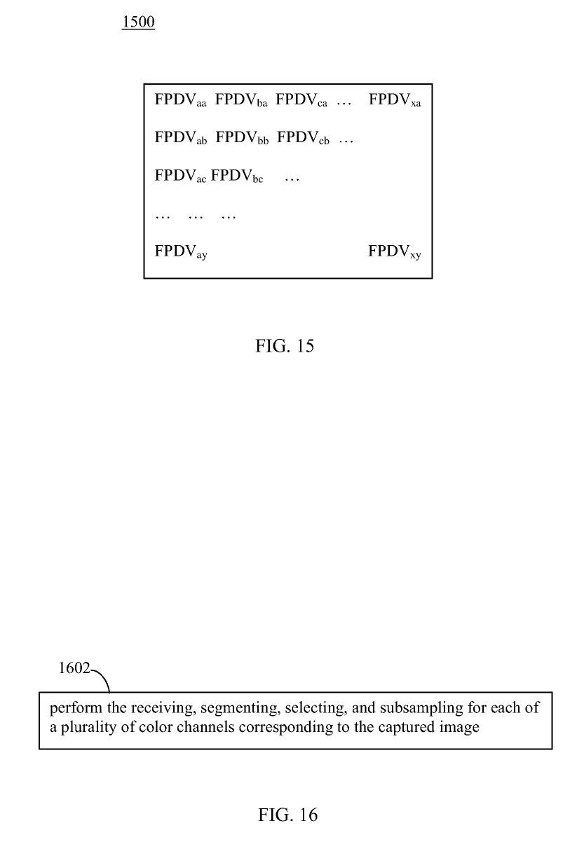

Equation 3 can be used to calculate a filtered pixel data value for each N×M array portion 902aa-902xy of the entire array 900 shown in FIG. 9. For example, FIG. 15 shows a second array 1500 of filtered pixel data values FPDVaa-FPDVxy. Each of filtered pixel data values FPDVaa-FPDVxy may be calculated according to Equation 3, by applying a selected subsampling pattern to each N by M array portion. Second array 1500 corresponds to a down-sized version of the captured image corresponding to array 900. Referring to FIG. 7, array 900 may correspond to X by Y pixel image 702, and array 1500 may correspond to x by y pixel image 704. Second array 1500 is a down-sized version of a captured image, and thus may be suitable for display on a relatively small display screen, such as display 120 of mobile device 100.

In an embodiment, array 1500 is a down-sized version of a single color channel corresponding to a captured image. For example, array 1500 may be a down-sized version of array 1000 shown in FIG. 10, which contains red color data values. A down-sized array may be generated in a similar fashion for other color channels. Thus, in an embodiment, flowchart 800 may include an additional step 1602 shown in FIG. 16, to process additional color channels. In step 1602, the receiving, segmenting, selecting, and subsampling of steps 802, 804, 806, and 808 may be performed for each of a plurality of color channels corresponding to the captured image. For example, a first iteration of steps 802, 804, 806, and 808 may be performed on red color channel 502 shown in FIG. 5. Second and third iterations of steps 802, 804, 806, and 808 may be performed on green color channel 504 and blue color channel 506, corresponding to the same captured image as red channel 502 of the first iteration.

Note that in an embodiment, for processing of additional color channels of a captured image, the receiving, segmenting, and subsampling of steps 802, 804, and 808 may be performed using the same subsample patterns selected during the first color channel iteration of step 806. Thus, in such an embodiment, step 806 does not need to be repeated for color channels subsequent to the first color channel.

Furthermore, flowchart 800 may be repeated for each captured image in a video stream. In this manner, down-sized images may be generated to be shown in sequence on a smaller display, to provide video on the smaller display.

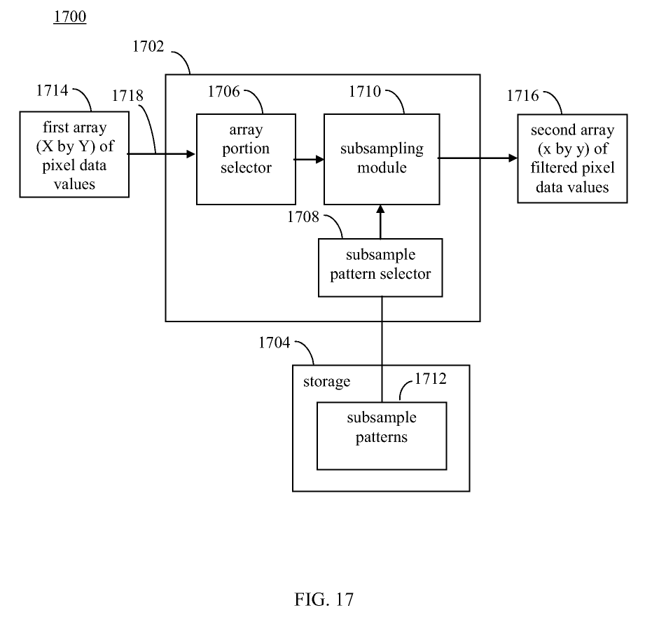

A device may be configured in a variety of ways to implement flowchart 800 of FIG. 8, in embodiments. For example, FIG. 17 shows a block diagram of an image subsampling system 1700, according to an embodiment of the present invention. System 1700 includes an image array subsampler module 1702 and storage 1704. Image array subsampler module 1702 includes an array portion selector 1706, a subsample pattern selector 1708, and a subsampling module 1710. Image array subsampler module 1702, including array portion selector 1706, subsample pattern selector 1708, and subsampling module 1710, may be implemented in hardware, software, firmware, or any combination thereof. For example, in an embodiment, image array subsampler module 1702 may be implemented as one or more blocks/modules of code that is executed by a processor, such as CPU 114 shown in FIG. 1. Alternatively, image array subsampler module 1702 may be implemented as hardware logic in an integrated circuit, such as an application specific integrated circuit (ASIC). In an embodiment, image array subsampler module 1702 may be implemented in image processor 136 shown in FIG. 1. System 1700 is described in further detail as follows.

Array portion selector 1706 may be configured to perform steps 802 and 804 of flowchart 800 in FIG. 8. Array portion selector 1706 receives N by M array portions 1718 of a first array 1714 of pixel data values that correspond to a captured image. For example, first array 1714 may be array 900, and N by M array portions 1718 may be N by M array portions 902aa-xx shown in FIG. 9. Array portion selector 1706 selects N by M array portions 1718 from first array 1718 to perform step 804 (segmenting first array 1714). For example, array portion selector 1706 may receive N by M array portions 1718 directly from an image processor, such as image processor 106 in FIG. 1, or may receive N by M array portions 1718 from storage, such as storage 124 in FIG. 1. Array portion selector 1706 may be configured to segment first array 1714 into N by M array portions 1718 by receiving/requesting one N by M array portion 1718 at a time, or by dividing first array 1714 into a plurality of N by M array portions 1718 in memory. Array portion selector 1706 may include a counter to count out a number of bits/bytes/data words (e.g., such as data word 600 shown in FIG. 6) received from array 1714 until an N by M array portion 1718 is received. For example, for a 4 by 4 array portion 1718, the counter counts out 16 data words. For a 6 by 3 array portion 1718, the counter counts out 18 data words. Array portion selector 1706 may be configured in this manner or other ways, as would be known to persons skilled in the relevant art(s).

Subsample pattern selector 1708 may be configured to perform step 806 of flowchart 800. As shown in FIG. 17, subsample pattern selector 1708 is configured to select a subsample pattern for each N by M array portion 1718 from subsample patterns 1712 in storage 1704 so that each N by M array portion 1718 has a corresponding selected subsample pattern. Storage 1704 stores subsample patterns 1712, which may include any number of subsample patterns. For example, in an embodiment, subsample patterns 1100, 1200, 1300, and 1400 may be included in subsample patterns 1712, possibly with one or more additional and/or alternative subsample patterns. Storage 1704 may be any type of storage device mentioned elsewhere herein or otherwise known, such as storage 124 shown in FIG. 1.

Subsampling module 1710 may be configured to perform step 808 of flowchart 800. As shown in FIG. 17, subsampling module 1710 receives selected N by M array portions from array portion selector 1706, and receives corresponding selected subsample patterns from subsample pattern selector 1708. Subsampling module 1710 is configured to subsample each N by M array portion according to the corresponding selected subsample pattern to generate a second array 1716 of filtered pixel data values. In an embodiment, subsampling module 1710 is configured to calculate a filtered pixel data value for each N by M array portion by applying a function to a subset of the plurality of pixel data values of the N by M array portion according to the corresponding selected subsample pattern. Second array 1716 corresponds to a down-sized version of the captured image corresponding to first array 1714.

In embodiments, image subsampling system 1700 is configured to perform its functions for one or more color channels of each captured image, such as for captured images in a video stream.

If the same subsample pattern is used for all N by M array portions for a particular captured image, a fixed pattern noise may appear. To mitigate such fixed pattern noise, subsample pattern selector 1708 may be configured to avoid repeating selection of subsample patterns from subsample patterns 1712 in some manner. This may be accomplished in a variety of ways. For example, in one embodiment, subsample pattern selector 1708 may be configured to select subsample patterns such that adjacent N by M data array portions 1718 in array 1714 have non-matching subsample patterns. For example, referring to FIG. 9, subsample pattern selector 1708 may be configured so that different subsampling patterns (e.g., subsampling patterns 1100 and 1200) are selected for adjacent N by M array portions 902aa and 902ba, as well as for adjacent N by M array portions 902aa and 902ab. Subsample pattern selector 1708 may select different subsample patterns for each of N by M array portions 902ba, 902ab, 902cb, and 902bc. Different subsample patterns may be selected for adjacent array portions in rows and/or columns of an array. Subsample pattern selector 1708 may track selections of subsample patterns to ensure that different subsampling patterns are selected for adjacent N by M array portions.

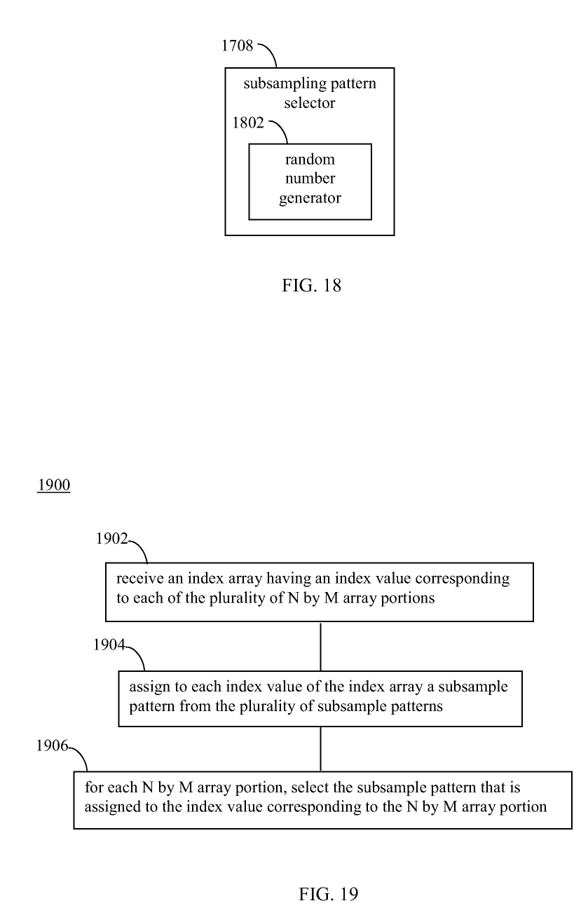

In another embodiment, subsample pattern selector 1708 selects subsample patterns from subsample patterns 1712 in a random (e.g., true random or pseudo-random) manner. For instance, as shown in FIG. 18, subsample pattern selector 1708 may include a random number generator 1802, according to an embodiment of the present invention. Random number generator 1802 can generate a random number each time subsample pattern selector 1708 needs to select a subsample pattern from subsample patterns 1712. The random number can be used as an index for subsample patterns 1712, which may include subsample patterns that are indexed by associated index numbers. Random number generator 1802 can be a true random number generator, or a pseudo random number generator based on a deterministic computation.

In another embodiment, subsample pattern selector 1708 selects subsample patterns from subsample patterns 1712 according to an index array. For example, subsample pattern selector 1708 can be configured to perform flowchart 1900 shown in FIG. 19. Flowchart 1900 provides example steps for selecting subsample patterns according to an index array, according to an embodiment of the present invention. In an embodiment, flowchart 1900 can be performed during step 806 of flowchart 800.

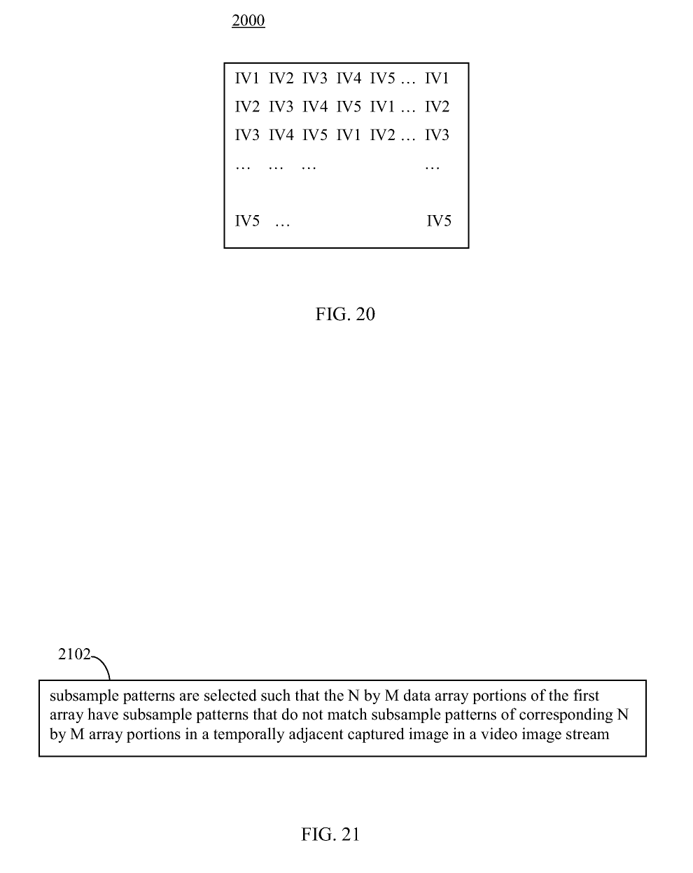

Flowchart 1900 begins with step 1902. In step 1902, an index array is received having an index value corresponding to each of the plurality of N by M array portions. For instance, FIG. 20 shows an example index array 2000, according to an embodiment of the present invention. Index array 2000 includes a plurality of index values (IV). Any number of index values IV may be used, in embodiments. For instance, in the example of FIG. 20, five index values, IV1-IV5 are present that are distributed throughout index array 2000, such that an index value IV is present corresponding to each N by M array portion of an image data array being processed. For example, index array 2000 may include an index value IV corresponding to each of N by M array portions 902aa-902xy.

In the example of FIG. 20, index values IV1-IV5 are assigned in index array 2000 in a repeating pattern—IV1 IV2 IV3 IV4 IV5—but a repeating pattern is not required. In embodiments, index values in an index array may be assigned in any manner, including a repeating pattern, a random pattern, etc. According to the repeating pattern of FIG. 20, index values IV1-IV5 are positioned such that no identical index values IV are adjacent to each other in index array 2000, to avoid a fixed noise pattern, but this is not required in all embodiments.

In step 1904, each index value of the index array is assigned a subsample pattern from the plurality of subsample patterns. In an embodiment, subsample pattern selector 1708 selects a different subsample pattern of subsample patterns 1712 for each index value. In the current example, subsample pattern selector 1708 selects five subsampling patterns to correspond to index values IV1-IV5. For instance, subsample pattern 1100 of FIG. 11 may be assigned to index value IV1, subsample pattern 1200 of FIG. 12 may be assigned to index value IV2, subsample pattern 1300 of FIG. 13 may be assigned to index value IV3, subsample pattern 1400 of FIG. 14 may be assigned to index value IV4, and another subsample pattern may be assigned to index value IV5.

In step 1906, for each N by M array portion, the subsample pattern that is assigned to the index value corresponding to the N by M array portion is selected. According to step 1906, step 806 of flowchart 800 is performed by selecting the subsample pattern for an N by M array portion according to the index value assigned in the index array. For example, referring to index array 2000 of FIG. 20, and array 900 of FIG. 9, the subsample portion corresponding to IV1 (e.g., subsample pattern 1100) is selected for N by M array portion 902aa. The subsample portion corresponding to IV2 (e.g., subsample pattern 1200) is selected for N by M array portion 902ba. The subsample portion corresponding to IV3 (e.g., subsample pattern 1300) is selected for N by M array portion 902ca. This process is continued for the remaining N by M array portions 902 of array 900.

According to flowchart 1900, the distribution of subsample patterns applied to N by M array portions of an array can be controlled by inserting the index values IV into an index array in any desired manner. Subsampling patterns can be reassigned to each index value periodically, such as each time a new captured image is being processed, to avoid a noise pattern occurring in a video display in the time domain.

As described above, if the same subsample pattern is used for all N by M array portions for a particular captured image, a fixed pattern noise may appear. A solution to this problem described above is to avoid using the same sampling pattern for adjacent array portions (e.g., avoiding repetition in the “spatial domain”). A similar problem can occur in the time domain, if the same subsample pattern is used for a particular N by M array portion location across multiple sequential captured images. To mitigate such a noise pattern issue, subsample pattern selector 1708 may be configured to avoid repeating selection of the same subsample pattern from subsample patterns 1712 for images captured adjacently in the time domain. Thus, in an embodiment, flowchart 800 may include step 2102 shown in FIG. 21.

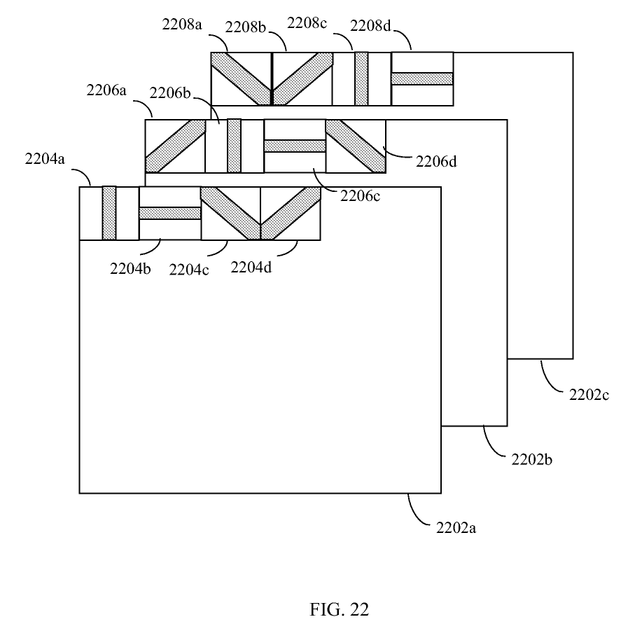

In step 2102, subsample patterns are selected such that the N by M data array portions of the first array have subsample patterns that do not match subsample patterns of corresponding N by M array portions in a temporally adjacent captured image in a video image stream. For example, FIG. 22 shows first, second, and third arrays 2202a-2202c of pixel data values, corresponding to three sequentially captured images of a video stream. FIG. 22 also shows example selected subsampling patterns for arrays 2202a-2202c, according to an example embodiment of the present invention. In FIG. 22, first array 2202a corresponds to a first captured image, second array 2202b corresponds to a second captured image, and third array 2202c corresponds to a third captured image.

Four subsample patterns are shown in FIG. 22 for each of arrays 2202a-2202c. Additional subsample patterns are not shown in FIG. 22, for ease of illustration. As shown in FIG. 22, subsample patterns in corresponding locations/coordinates of adjacent arrays do not match. For example, a subsample pattern 2206a selected for a first N by M array portion of second array 2202b has a forward diagonal bar pattern. The forward diagonal bar pattern is different from a vertical bar pattern of a subsample pattern 2204a of prior array 2202a at the same coordinates. Subsample pattern 2208a selected for the first N by M array portion of array 2202c has a backward diagonal bar pattern. The backward diagonal bar pattern is different from the forward diagonal bar pattern of subsample pattern 2206a of prior array 2202b at the same coordinates. Different subsample patterns are also selected for other adjacent array portions of arrays 2202a-2202c (e.g., sequential subsample patterns 2204b, 2206b, and 2208b are different from each other; sequential subsample patterns 2204c, 2206c, and 2208c are different from each other; sequential subsample patterns 2204d, 2206d, and 2208d are different from each other).

Subsample patterns adjacent in the time domain may be selected to be different in a variety of ways. For example, selection of adjacent subsample patterns in the time domain may be performed in the manners described above for adjacent subsample patterns in the spatial (same image) domain, including through random selection, using an index array, etc.

### EXAMPLE SOFTWARE EMBODIMENTS

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system and to storing software in a computer system or other device. The invention, in an embodiment, is directed to such computer program products.

In an embodiment where aspects of the present invention are implemented using software/firmware, the software/firmware may be stored in a computer program product and loaded into a computer system or other device using a removable storage drive, hard drive, or communications interface. The computer system or other device may execute the software/firmware from storage such as a hard drive or memory device (e.g., a ROM device such as an electrically erasable ROM, electrically programmable ROM, a RAM device such as a static RAM, dynamic RAM, etc.). This control logic software/firmware, when executed by a processor, causes the processor to perform the functions of the invention as described herein.

According to an example embodiment, a mobile device may execute computer-readable instructions to process image data, as further described elsewhere herein (e.g., as described with respect to flowchart 800 of FIG. 8), and as recited in the claims appended hereto.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for processing captured image data, comprising:
receiving a first array of pixel data values corresponding to a captured image;
segmenting the first array into a plurality of N by M array portions so that each N by M array portion of the plurality of N by M array portions includes a corresponding plurality of pixel data values;
selecting a subsample pattern for each N by M array portion of the plurality of N by M array portions from a plurality of subsample patterns so that each N by M array portion has a corresponding selected subsample pattern, and
subsampling each N by M array portion according to the corresponding selected subsample pattern to generate a second array of filtered pixel data values;
wherein the second array of filtered pixel data values corresponds to a down-sized version of the captured image.

2. The method of claim 1, wherein said subsampling comprises:
calculating a filtered pixel data value for each N by M array portion by applying a function to a subset of the plurality of pixel data values of the N by M array portion according to the corresponding selected subsample pattern.

3. The method of claim 1, wherein said selecting comprises:
randomly selecting a subsample pattern from the plurality of subsample patterns for each N by M array portion of the plurality of N by M array portions.

4. The method of claim 1, wherein said selecting comprises:
pseudo-randomly selecting a subsample pattern from the plurality of subsample patterns for each N by M array portion of the plurality of N by M array portions.

5. The method of claim 1, wherein said selecting comprises:
receiving an index array having an index value corresponding to each of the plurality of N by M array portions;
assigning a subsample pattern from the plurality of subsample patterns to each index value of the index array; and
for each N by M array portion, selecting the subsample pattern that is assigned to the index value corresponding to the N by M array portion.

6. The method of claim 1, wherein said selecting comprises:
selecting subsample patterns such that adjacent N by M data array portions in the first array have non-matching subsample patterns.

7. The method of claim 1, wherein said selecting comprises:
selecting subsample patterns such that the N by M data array portions of the first array have selected subsample patterns that do not match selected subsample patterns of corresponding N by M array portions in an array corresponding to a temporally adjacent previously captured image in a video image stream.

8. The method of claim 1, further comprising:
receiving a third array of pixel data values corresponding to a second captured image;
segmenting the second array into a second plurality of N by M array portions portions so that each N by M array portion of the second plurality of N by M array portions includes a corresponding plurality of pixel data values;
selecting a subsample pattern from the plurality of subsample patterns for each N by M array portion of the second plurality of N by M array portions so that each N by M array portion of the second plurality of N by M array portions has a corresponding selected subsample pattern, and
subsampling each N by M array portion of the second plurality of N by M array portions according to the corresponding selected subsample pattern to generate a fourth array of filtered pixel data values;
wherein the fourth array of filtered pixel data values corresponds to a down-sized version of the second captured image; and
wherein the first captured image and the second captured image are adjacent captured images of captured video.

9. The method of claim 8, wherein the first plurality of N by M array portions has a first N by M array portion positioned at a first coordinate for the first array, and the second plurality of N by M array portions has a second N by M array portion positioned at the first coordinate in the third array, wherein said selecting a subsample pattern from the plurality of subsample patterns for each N by M array portion of the second plurality of N by M array portions comprises:
selecting a subsample pattern for the second N by M array portion that is different from a subsample pattern selected for the first N by M array portion.

10. The method of claim 1, further comprising:
performing said receiving, segmenting, selecting, and subsampling steps for each of a plurality of color channels corresponding to the captured image.

11. The method of claim 1, further comprising:
performing said receiving, segmenting, selecting, and subsampling steps for a first color channel corresponding to the captured image; and
performing said receiving, segmenting, and subsampling steps for at least one additional color channel corresponding to the captured image, wherein said subsampling step is performed for the at least one additional color channel using the subsample patterns selected for the plurality of N by M array portions for the first color channel.

12. An image subsampling system, comprising:
an image array portion selector configured to select a plurality of N by M array portions from a first array of pixel data values that correspond to a captured image, wherein each N by M array portion of the plurality of N by M array portions includes a corresponding plurality of pixel data values;
a subsampling pattern selector configured to select a subsample pattern for each N by M array portion of the plurality of N by M array portions from a plurality of subsample patterns so that each N by M array portion has a corresponding selected subsample pattern, and
a subsampling module configured to subsample each N by M array portion according to the corresponding selected subsample pattern to generate a second array of filtered pixel data values;
wherein the second array of filtered pixel data values corresponds to a down-sized version of the captured image.

13. The system of claim 12, wherein the subsampling module is configured to calculate a filtered pixel data value for each N by M array portion by applying a function to a subset of the plurality of pixel data values of the N by M array portion according to the corresponding selected subsample pattern.

14. The system of claim 12, wherein the subsampling pattern selector comprises a random number generator, wherein the subsampling pattern selector is configured to randomly select a subsample pattern from the plurality of subsample patterns for each N by M array portion of the plurality of N by M array portions.

15. The system of claim 14, wherein the random number generator generates pseudo-random numbers.

16. The system of claim 12, wherein the subsampling pattern selector is configured to access an index array having an index value corresponding to each of the plurality of N by M array portions;
wherein the subsampling pattern selector is configured to assign a subsample pattern from the plurality of subsample patterns to each index value of the index array; and
wherein the subsampling pattern selector is configured to select for each N by M array portion the subsample pattern that is assigned to the index value corresponding to the N by M array portion.

17. The system of claim 12, wherein the subsampling pattern selector is configured to select subsample patterns such that adjacent N by M data array portions in the first array have non-matching subsample patterns.

18. The system of claim 12, wherein the subsampling pattern selector is configured to select subsample patterns such that the N by M data array portions of the first array have selected subsample patterns that do not match selected subsample patterns of corresponding N by M array portions in an array corresponding to a temporally adjacent previously captured image in a video image stream.

19. The system of claim 1, wherein the image array portion selector, the subsampling pattern selector, and the subsampling module are configured to operate on each of a plurality of color channels corresponding to the captured image.

20. A computer program product comprising a computer usable medium having computer readable program code means embodied in said medium for processing captured image data, comprising:
a first computer readable program code means for enabling a processor to receive a first array of pixel data values corresponding to a captured image;
a second computer readable program code means for enabling a processor to segment the first array into a plurality of N by M array portions so that each N by M array portion of the plurality of N by M array portions includes a corresponding plurality of pixel data values;
a third computer readable program code means for enabling a processor to select a subsample pattern for each N by M array portion of the plurality of N by M array portions from a plurality of subsample patterns so that each N by M array portion has a corresponding selected subsample pattern, and
a fourth computer readable program code means for enabling a processor to subsample each N by M array portion according to the corresponding selected subsample pattern to generate a second array of filtered pixel data values;
wherein the second array of filtered pixel data values corresponds to a down-sized version of the captured image.
